(19) United States
(12) Patent Application Publication
(10) Pub. No.: US 2009/0119500 A1
(43) Pub. Date: May 7, 2009

(54) Managing software configuration using mapping and repeatable processes

(75) Inventors: Dan Roth, Bellevue, WA (US); Asaf Kashi, Bellevue, WA (US); Alexander T. Weinert, Seattle, WA (US); Craig V. McMurtry, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/934,619

(22) Filed: Nov. 2, 2007

(51) Int. Cl. G06F 1/24; H04L 9/32

(52) U.S. Cl. 713/100; 726/21

(57) ABSTRACT

The embodiments described herein generally relate to a method and system of injecting automated repeatable processes, or workflows, into software configuration management sequences. The benefits of such a system include the ability to delegate configurability change abilities to an IT administrator while still maintaining efficiency and management control over such changes. A request made by a system administrator to process configuration data may be subject to multiple phases of processing, such as, authentication, authorization, and action. A declarative mapping associates workflows, or meaningful repeatable processes, with the configuration process request criteria and processing phase. The mapping may be created by, or at the direction of, management through the application of the processing concept in API or UI. Upon a triggering event, e.g., receiving a configuration processing request, a stored mapping based on the attributes of the principal and request type may be consulted to determine the workflows which may then execute.

### BACKGROUND

Business organizations often desire to manage computer software configuration access and/or changes to computer software configuration in and of itself. For example, the management of a business organization may desire to control an IT (Information Technology) administrator's, or IT technician's, ability to change policies regarding software configurability, such as changing the expiration period of an email group for new employees from three (3) months to thirty (30) days. To control such configurability changes, management often secures the directories in which files reside so that only specific accounts or users may access such directories. In other words, only certain management personnel may have access to such directories. Or, an individual attempting to access a specific directory may need to ask for permission from a manager or specific department to obtain such access or to have an approved account make the requested change. Alternatively, some business organizations may rely on the IT administrator to make configuration changes based on his/her judgment.

Manual determination of the location and access privileges to the approved account is inefficient, especially in a large business organization where delays in waiting for individuals or entities to grant necessary permissions or make changes with approved accounts, for example, may result. Further, where management is not organized to provide clear guidelines of policies and procedures for accessing an approved account or for otherwise obtaining approval to make a configuration change, an IT administrator may be faced with the inability to determine how to gain access or to make configuration changes at all. The problem is exacerbated when the overall management or individuals or entities responsible for making configuration management decisions in a large organization changes frequently, and the ability to manage configuration changes on a daily basis thus becomes decentralized, increasingly difficult to accomplish in a timely manner, and subject to rampant inconsistencies.

Although specific problems have been addressed in this Background, this disclosure is not intended in any way to be limited to solving those specific problems.

### SUMMARY

Embodiments of the present invention generally relate to applying mapping and repeatable processes, or workflows, to the management of software configuration and associated policies. Where an individual, such as an IT administrator, desires to make a software configuration change, automated workflows mapped for such requests will automatically be triggered based on the content and attributes of such request. Workflows, for example, may be triggered to request approval from the entity or individual with authority to control the desired configuration change. In such a case, the ability to change a configuration setting is delegated to an IT administrator while ensuring that management is notified of the change and/or given the opportunity to approve or deny it. Once a configuration change is made, other workflows, for example, may notify, or update, particular entities or individuals of the change in accordance with an embodiment of the present invention. A particular embodiment thus provides for the triggering of certain workflows based on the attributes of the particular requestor, or system administrator, the target change requested, the type of configuration change requested, and the phase of processing the request, e.g., authentication, authorization, and/or action. Further embodiments relate to the creation of a mapping for particular configuration request criteria, in which such mapping is pre-defined by a person with management authority to make configuration control decisions or by an IT administrator acting under the direction of such a person, for example. This mapping triggers the workflows which should be executed for the particular request criteria. Further yet, embodiments relate to the injection of workflows using application programming interfaces (“API”) and user interfaces (“UI”) and the ability of the computer system to support rich semantic expressions of associating repeatable processes with configuration request processing.

This Summary is provided to introduce a selection of concepts in a simplified form that is further described below in the Detailed Description. This Summary is not intended to identify key or essential features of the claimed subject matter, nor is it intended to be used in any way as to limit the scope of the claimed subject matter.

### BRIEF DESCRIPTION OF THE DRAWINGS

FIG. 1 illustrates an exemplary logical representation of a network environment for creating a mapping of workflows associated with software configuration processing requests, the storage of such mapping, and the consulting of such mapping upon a particular request type by a system administrator or other requester in accordance with an embodiment of the present invention.

FIG. 2 depicts an exemplary detailed version of the user interface shown in FIG. 1 which is seen by management or by a system administrator acting at the direction of management and is used for creating a mapping for a certain configuration processing request type by a certain requester on a certain target and during a certain processing phase in accordance with an embodiment of the present invention.

FIG. 3 depicts an exemplary flow diagram illustrating the operational characteristics of a process for creating and storing a mapping for a software configuration processing request as shown in the logical representation in FIG. 1 in accordance with an embodiment of the present invention.

FIG. 4 illustrates an exemplary user interface showing the different types of administrative configuration settings that a system administrator may be able to view/change in accordance with an embodiment of the present invention.

FIG. 5 illustrates an exemplary user interface showing the particular configuration settings that a system administrator can change based on the selection made by the administrator in FIG. 4 in accordance with an embodiment of the present invention.

FIG. 6 depicts an exemplary flow diagram illustrating the operational characteristics of a process for responding to a request to make a configuration change with a particular phase “X”, e.g., authentication, authorization, or action, based on pre-defined mappings in accordance with an embodiment of the present invention.

FIG. 7 is a flow diagram illustrating the operational characteristics of a process for an exemplary configuration processing request at the authentication phase based on pre-defined mappings in accordance with an embodiment of the present invention.

FIG. 8 is a flow diagram illustrating the operational characteristics of a process for an exemplary configuration processing request at the authorization phase based on pre-defined mappings in accordance with an embodiment of the present invention.

FIG. 9 is a flow diagram illustrating the operational characteristics of a process for an exemplary configuration processing request at the action phase based on pre-defined mappings in accordance with an embodiment of the present invention.

FIG. 10 illustrates a logical representation of exemplary functional component modules for processing a software configuration processing request in accordance with an embodiment of the present invention.

FIG. 11 depicts an exemplary computing system upon which embodiments of the present disclosure may be implemented in accordance with an embodiment of the present invention.

### DETAILED DESCRIPTION

This disclosure will now more fully describe exemplary embodiments with reference to the accompanying drawings, in which specific embodiments are shown. Other aspects may, however, be embodied in many different forms and the inclusion of specific embodiments in this disclosure should not be construed as limiting such aspects to the embodiments set forth herein. Rather, the embodiments depicted in the drawings are included to provide a disclosure that is thorough and complete and which fully conveys the intended scope to those skilled in the art. Dashed lines may be used to show optional components or operations.

Embodiments of the present invention generally relate to applying mapping and meaningful repeatable processes, or workflows, to the management of software configuration processing requests. In an embodiment, workflows for processing a software configuration request are associated with one or more of the three phases of the Entity Management Processing Model, or Core Request Processing Model. In general, requests in an entity management system may be subject to at least three phases, namely: (1) Authentication; (2) Authorization; and (3) Action. A fourth phase, Consequences Due to Set Transitions, or Entity Data Change, may also be necessary to respond to state changes resulting from execution of a request. In general, authentication is the first phase of request processing and involves determining the identity of the principal, or requestor, making the request. The second phase, i.e., authorization, involves determining whether the system should execute the specific request against the specific target. The third phase, i.e., action, actually executes the request and thus changes data or delivers results to the requester. In creating a result, or change, the action phase may be non-revocable according to some embodiments. Finally, a fourth phase, set transitions, or consequence processing, may be executed to manage state changes, if any, caused by the action phase of the request. A workflow(s) may be associated with each phase of a request. Or, no workflows may be associated with a particular phase in accordance with some embodiments. Further, not all phases are necessary for a given request in some embodiments. For example, the system may not require the requester to be authorized but may give approval to all requesters to proceed. Further yet, additional phases or sub-phases may be included without departing from the spirit and scope of the present invention.

Embodiments relate to the concept and process of creating a “mapping” for associating desired workflows with certain phases for the processing of a configuration processing request, e.g., a request to change software configurability, such as a request to change the password reset settings. Such association involves the injection of workflows into the processing of a configuration processing request based on the criteria of the request, e.g., the requesting agent (“requester” or “principal” or “administrator”), the request type (such as to change password reset settings), etc. This mapping may be created using API or UI and may be made by management or by an IT administrator acting under the direction of someone in a position of authority, e.g., a manager. Alternatively, the mapping may be created using computer programming techniques. Once this mapping is created, it is consulted when a particular request is made to process a configuration data request. The mapping determines which workflows to execute for each phase. For example, workflows may be triggered to determine the requestor's identity, i.e., authentication, in which a workflow may be triggered requiring a requester operating outside the corporate network to pass biometric authentication, for example. If the requester has rights to view configuration settings and changes a configuration setting, workflows may then be triggered to request approval from a certain higher authority to approve the change(s), in which an email approval request, for example, may automatically be sent to a person able to grant such permission to the system administrator. A corresponding approval code, for example, may then be sent back to the requester for entry and to allow the process to execute. In another embodiment, the process may be executed when the higher authority clicks “approve” in the email approval request message. The configuration setting is then automatically updated in the system. Workflows may also be included in the mapping to respond to changes made, for example, in which notices may be sent to specific entities informing of the configuration change(s). Workflows can thus be associated with each phase of processing a configuration data change request such that the management of a business organization can control the actual ability and resulting process of making changes at the software configuration level.

Thus, in an embodiment, to process a configuration processing request, e.g., to change a configuration setting, the authentication phase involves determining the identity of the system administrator, or other requester, attempting to make the change. In the authorization phase, it is determined if the requester is authorized to perform the requested configuration processing. After the authentication and authorization phases are completed, the requested configuration processing is carried out, or executed, in the action phase. While the action phase runs after the authentication and authorization phases have completed, there is no requirement to have both authentication and authorization phases. Either one or both phases may be run before the action phase. If no such phases are required, the system is a rights-based system in accordance with an embodiment of the present invention. In such a rights-based system, whatever IT administrator, or other person, with rights to view the configuration settings can make changes to such data.

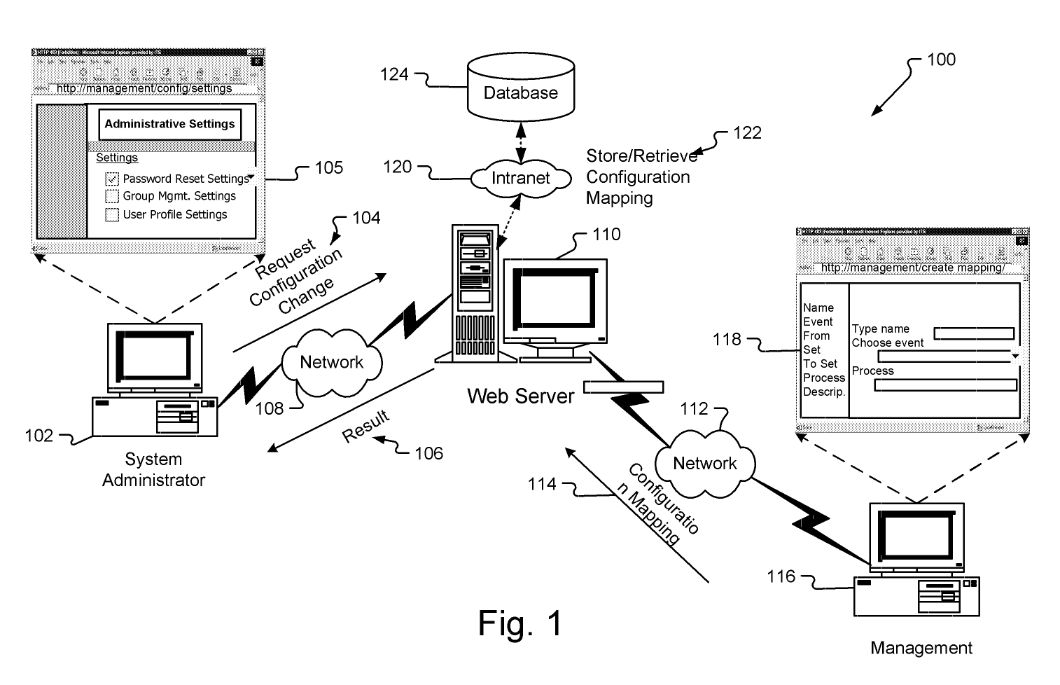

A network environment 100 for creating and retrieving a mapping for processing a request to make a software configuration change is shown in FIG. 1. In a particular embodiment, a system administrator (or IT technician, IT administrator, etc.) 102 makes a request 104 to make a change to a configuration setting, such as a change to the password reset settings, for example. This request may be made by the system administrator by opening a portal 105 showing the configuration settings choices, in which it is assumed that the administrator thus has rights to view such configuration settings, by navigating to the particular configuration settings of which a change to configurability is desired (for example, password reset settings), and by then making the change desired, such as by entering a new number in the field for password length. A change to the password reset settings could include a change of the length of the required password, such as from 8 to 10 characters in length, a change to the type of characters required to be used, such as alphanumeric or numbers only, etc. It is important to note that the system administrator may access the configuration settings through any means. Opening a portal and navigating to a desired settings page are only offered for exemplary purposes only. A person of ordinary skill in the art would understand that there are numerous ways in which a system administrator could enter a request to change a configuration setting. Further, the configurability change request 104 may be made by a number of means. For example, system administrator 102 could enter a change in a field box on the password reset settings page. Or, in a procedural system, more semantically meaningful requests may be used, such as, for example, the request “ChangeLength_Password_Reset_Settings.”

The configuration change request is transmitted across network 108 to web server 110. In response to this request 104, web server 110 retrieves a configuration mapping 122, in which the predetermined mapping associates, or “maps,” workflows to processing phases depending on the request. In this example, i.e., where the system administrator 102 wants to change the configuration of the password reset settings, the mapping would associate workflows specific to the current status of the system administrator, e.g., an Employee Without Rights to Make Configurability Changes Without Approval, and the particular change which the system administrator 102 desires to make, i.e., Change Password Reset Settings. The workflows which the mapping may designate as needing to be fired to accomplish such an action can include, for example, to validate the system administrator 102's identity by running a specific authentication workflow. In this example, the mapping is retrieved over the intranet 120 from database 124 which stores configuration mappings for particular configuration processing requests. Mappings are stored in database 124 after being created by a manager 116 with authority to control configurability changes or other person acting under the direction of someone with such authority. To create a configuration mapping 114, a member of management or person working at management's direction uses the user interface (“UI”) 118 for specifying the conditions and workflows for a particular request. Once created, the configuration mapping 114 is transmitted over network 112 to the web server 110 for storage 124. The stored mapping may then be retrieved 122 in response to the system administrator 102's particular configuration processing request. The mapping causes other actions, i.e., workflows, to take place to automatically authorize the requested configurability change, e.g., to send an email to a manager for approval, and/or notify other users of the request, e.g., inform the Vice President of Security that the password reset settings may be changed, among other things. After executing such workflows, the requested action, i.e., to change the configuration of the password reset settings, is taken in result step 106 over network 108. The benefits of such a system include the ability to delegate configurability change abilities to an IT administrator while still maintaining efficiency and consistent management control over such changes.

It is worth noting at the outset that FIG. 1 is merely an example of an environment for practicing the present invention. For example, FIG. 1 shows mappings created by management through the use of a computer programmer. However, embodiments of the invention also cover, for example, defining mappings on systems post-compilation by an IT technician or other person with similar permissions. The scope of the present invention is thus in no way limited to a developer-only concept. Similarly, while store/retrieve mapping 122 and database 124 show mappings stored in the database, the present invention is in no way limited to such storage. Any number of means of storage could be understood by those of ordinary skill in the art in accordance with other embodiments of the present invention. Store/retrieve 122 and database 124 are thus shown by way of example only. Indeed, system administrator 102, web server 110, management 116, networks 108 and 112, intranet 120, etc. are valid ways of practicing the present invention in accordance with an embodiment of the invention but are in no way intended to limit the scope of the invention. Further, the exemplary network environment 100 may be considered in terms of the specific components described, e.g., server, database, etc., or, alternatively, may be considered in terms of the analogous modules corresponding to such units, e.g., executing module, processing module, etc.

Similarly, while only one web server 110 is shown, more than one server computer or separate servers, e.g., a server farm (not shown), may be used in accordance with an embodiment of the present invention. Further, although only one user computer system 102 and one computer programmer system 116 are shown, multiple systems could communicate with web server 110. The network environment 100 is not limited to any particular implementation and instead embodies any computing environment upon which the functionality of the environment described herein may be practiced. Further, networks 108 and 112, although shown as two networks may be a single, private network, e.g., an intranet. In embodiments, networks 108 and 112 may be any type of network conventionally known to those skilled in the art. In accordance with an exemplary embodiment, the networks may be the global network (e.g., the Internet or World Wide Web, i.e., “Web” for short). They may also be a local area network or a wide area network. In accordance with embodiments of the present invention, communications over networks 108 and 112 occur according to one or more standard packet-based formats, e.g., H.323, IP, Ethernet, and/or ATM. Any conceivable environment or system may be understood by those of ordinary skill in the art. FIG. 1 is offered as an example only for purposes of understanding the teachings of the present invention.

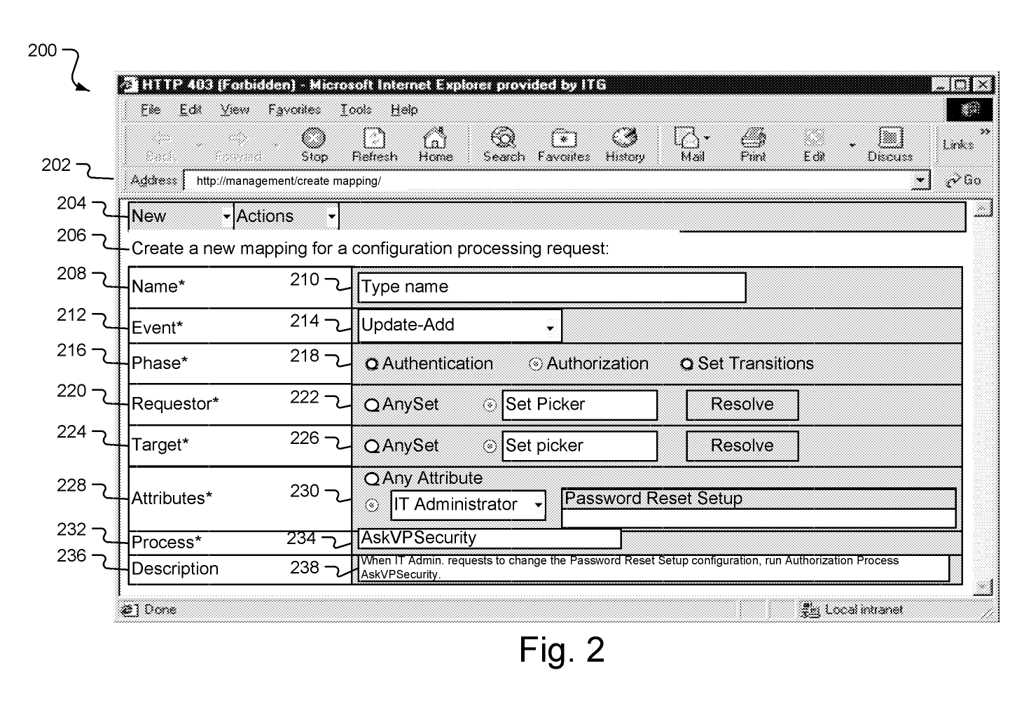

In a particular embodiment, user interface (UI) 200 shown in FIG. 2 may be used to create and/or edit a particular configuration mapping. As shown at 206, this particular example is used to create a new mapping for a configuration processing request. This UI may be accessed via the Internet through a specific URL 202. This URL is shown by way of example only. Any type, manner or form of access to a UI for creating a mapping may be covered by other embodiments of the present invention. Similarly, the scope of this invention is also intended to cover application or exposition of the concepts disclosed in API. User interface 200 is offered merely as an exemplary embodiment and is intended in no way to limit the scope of the invention. A person of ordinary skill in the art would understand the present invention's coverage of API access, as well as any number of means of access known to those of ordinary skill in the art.

User interface 200 enables management 116, or a person acting under the direction of management, to create a configuration mapping for associating a request processing phase with a configuration request type, particular process, requester, and target or target set. In an embodiment, the manager 116 must name 208 the mapping by typing a name in cell 210. The event 212 for triggering the mapping and processing must be specified and is shown as Update 214 in FIG. 2. Next, the phase 216 of the processing request for the mapping being created is selected as authentication, authorization, or set transitions in the radio button selections 218. Since each of the phases may have workflows associated with them, the ability to select the phase involved in the mapping exists at 218. The requester 220, or principal, must also be specified as a condition for the mapping. The requester may be “Any” 222, meaning that the mapping is not concerned with the set the requester is in, or may be selected, as shown with “Set Picker” according to one embodiment of the invention. The same concepts apply to the target entity 224 and 226 choices. A target entity is a particular group of settings. For example, a target entity could be a set of “most sensitive” configuration settings, including password reset settings and security settings. The set of “most sensitive” settings would be a target. Another example of a target entity is a set of “UI settings,” in which such target would require less authorization according to an embodiment of the present invention. Also, attributes 228 of the target or principal may be specified as shown by the selection of IT Administrator 230 and the attribute selection of Password Reset Setup. The process 232 is specified as AskVPSecurity 234 to map the workflow to the phase, principal, target, and request type to change password reset settings. Thus, as shown in description 236 and 238, this mapping provides for the processing of the expression, “When IT Admin. requests to change the Password Reset Setup configuration, run Authorization Process AskVPSecurity.” As is readily apparent, UI 200 is offered by way of example only and is intended in no way to limit the scope of the invention. Any number of conceivable UIs and possible mapping combinations could readily be understood by those of ordinary skill in the art. Further, in other embodiments, the steps described, e.g., 208, 212, etc., may be optional, as opposed to required, or may be a combination of optional and required steps.

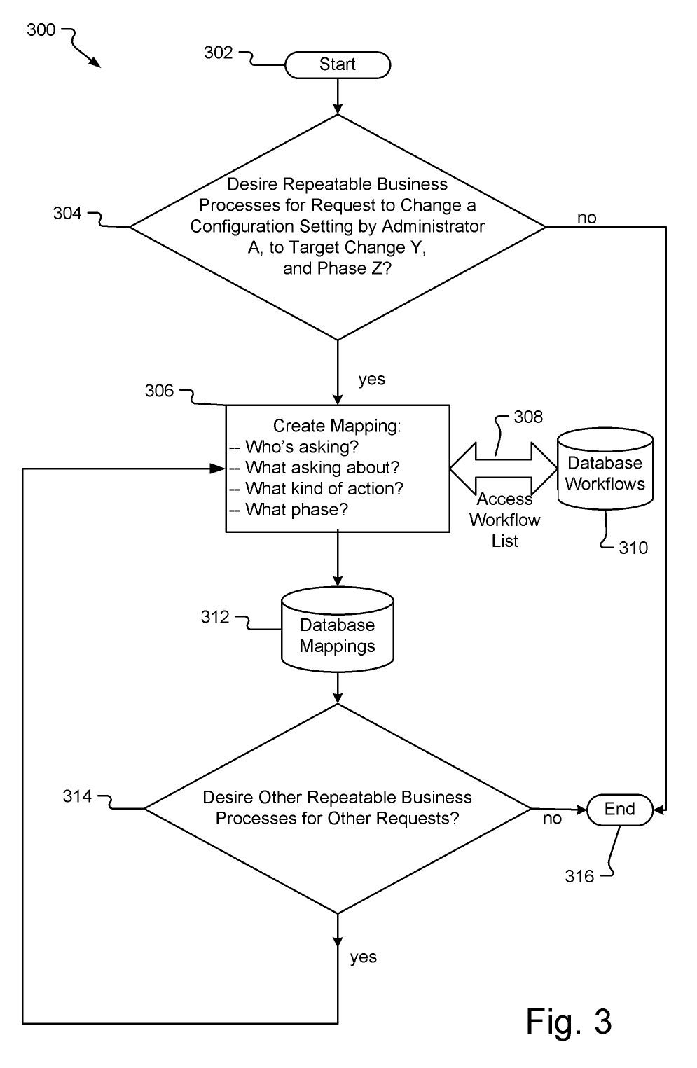

While FIG. 2 shows the UI 200 for creating a configuration mapping by management 116 of FIG. 1, FIG. 3 depicts the operational steps 300 for creating and storing a configuration mapping in accordance with an embodiment of the present invention. Start operation 302 is initiated and process 300 proceeds to query operation 304 in which it is determined whether management 116 desires to create a mapping of workflows for a certain request to change a configuration setting by administrator A, to target change Y, and in phase Z, i.e., authentication, authorization, and/or action. If it is desired to create such a mapping, flow branches YES to create mapping operation 306. If it is not desired to create such a mapping, flow branches NO to end operation 316. In an embodiment, in operation 306, four questions are asked for associating the conditions for the processing desired, namely: “(1) Who's asking? (2) What is being asked about? (3) What kind of action is desired? and (4) What phase of processing is this mapping desired for?” Available workflows may be accessed 308 from a database 310 of stored workflow programs based on these questions. Once the mapping of workflows is created, it is saved or stored in database 312 for later retrieval. Process 300 continues to query operation 314, in which it is determined whether management 116 desires to create any other configuration mappings for certain conditions. If further mappings are desired, flow branches YES to create configuration mapping operation 306 and the above process repeats. If no further mappings are desired, flow branches NO to end operation 316. While any means of storage or memory may be used, databases 310 and 312 are shown as exemplary storage means. As with FIG. 1, FIG. 3 is merely an example of possible operational characteristics for creating and storing a mapping for a configuration processing request in accordance with an embodiment of the present invention.

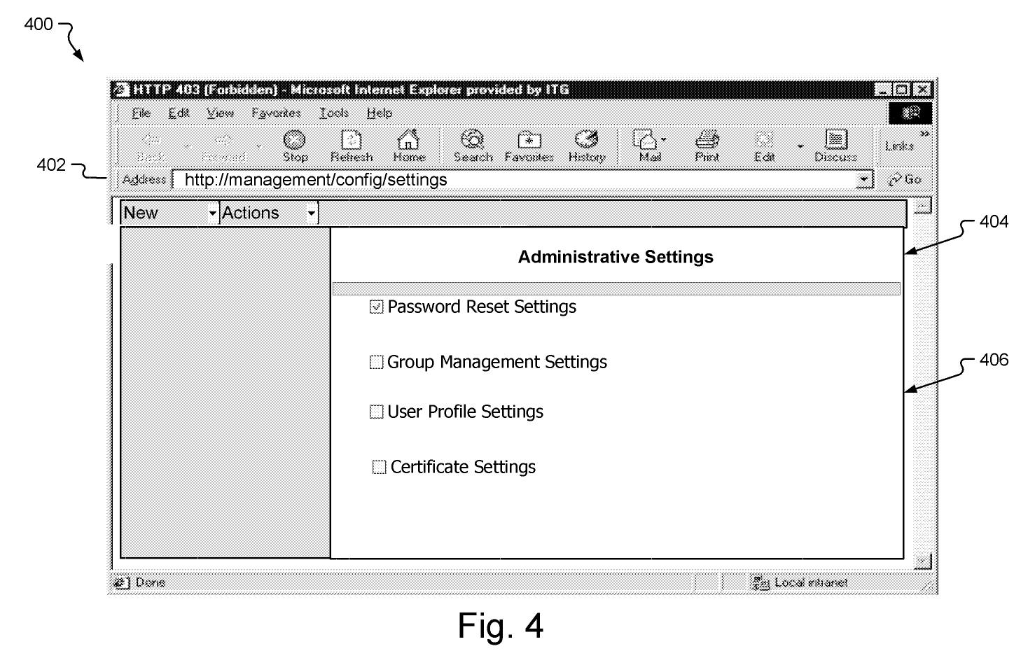

Turning now to FIG. 4, an exemplary UI 400 is shown illustrating the different types of administration configuration settings that a system administrator 102 may view. A system administrator 102 may open a portal showing configuration settings by typing in the URL 402 for such a webpage. The system administrator 102 may have a special URL access code to open such a portal. Regardless, it is assumed for example purposes, that the system administrator 102 has rights to view configuration data. The UI 400 shows administrative, or configuration, settings 404 and the possible types of particular configuration settings 406 which the system administrator 102 may select to change or view in detail. For example, Password Reset Settings relates to the length and type of password requirements. Group Management Settings relates to the expiration period of an email distribution group, for example, in which a system administrator could change the configuration of such expiration period from three (3) months to thirty (30) days, for example. User Profile Settings relates to the type of information that an employee or other user may enter to create a personal business profile. Such settings could be configured to add or delete birthdates, for example. Certificate Settings relates to the certificates required to enable communications between a client and server and could be configured to accept a digital token or electronic certificate, for example. The UI 400 shows the ability to select any of the Settings 406 by selecting the applicable box; however, any number of ways of selecting the Settings 406 could be reasonably understood by those of ordinary skill in the art, such as by clicking on the names or clicking on a Tab representing each category (not shown). Once a particular setting is selected, the system administrator 102 is able to navigate to the UI showing the particular details of the setting category selected.

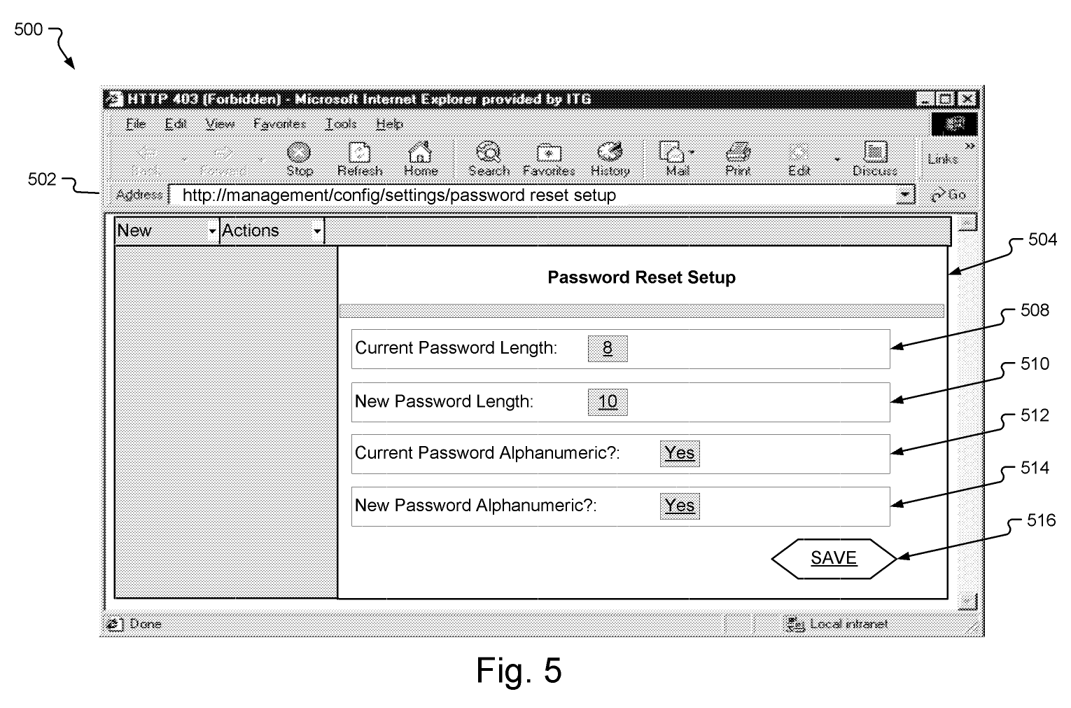

FIG. 5 shows the particular configuration details in UI 500 for the setting selected for Password Reset Setup 504, for example. The URL 502 indicates that the system administrator 102 has navigated to the password reset setup page. On this page, the system administrator 102 may now view and change the details of password reset setup. For example, the system administrator 102 may enter or select a new password length 510 to replace the current password length 508. The system administrator 102 may also select whether to require the new password to have alphanumeric characters 514 to match the current password requirements 512, etc. After making any changes, the system administrator 102 selects SAVE 516. Upon selecting SAVE 516, a pre-defined mapping is consulted (such as one created in FIG. 2) and workflows are triggered according to the mapping for the particular phase(s) of the request. For example, in the authorization phase of the request, such workflows could require that the Vice President of Security, such as shown in process step 234 in FIG. 2, be sent an email approval request to grant or deny the system administrator 102's request to change the password length from 8 characters to 10 characters. The Vice President of Security would receive the email in his/her Inbox, explaining the requested configuration change to the password reset settings. The Vice President would then have the option to approve or reject the change. If the Vice President approved the change, he/she could click “approve” in the email message, which would then cause the configuration setting to be updated in the system. Other means of executing the configuration setting upon approval could also be used in accordance with embodiments of the invention, such as sending an approval code to the system administrator 102, etc.

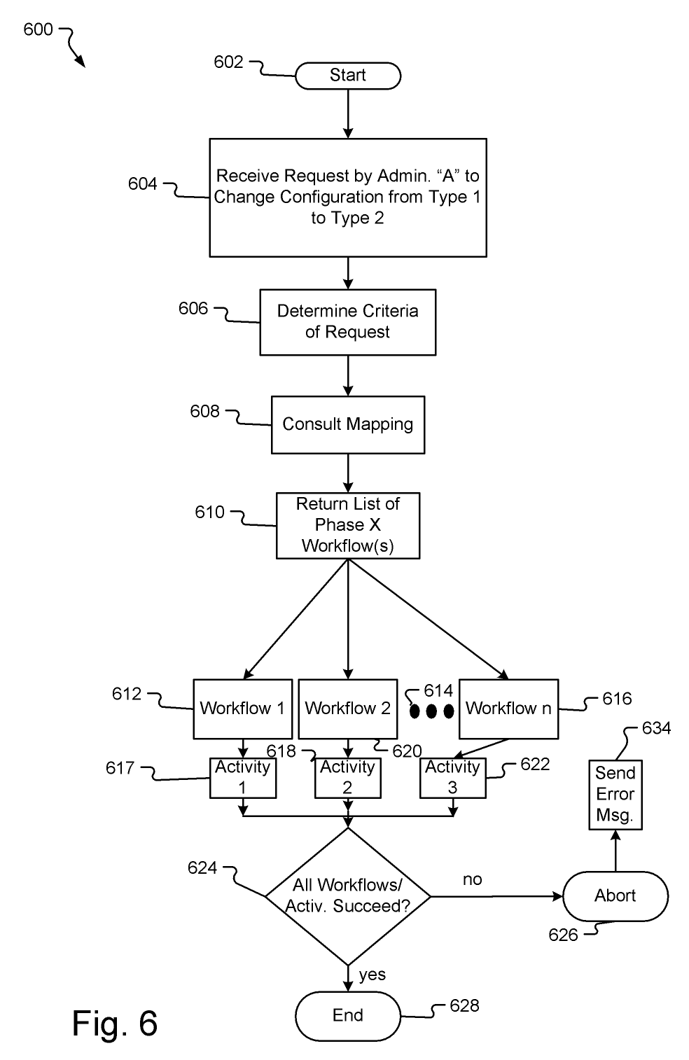

Turning now to FIG. 6, process 600 for triggering workflows associated with a pre-defined mapping is shown in accordance with an embodiment of the present invention. Start operation 602 is initiated in response to system administrator “A” opening a portal to view configuration settings. It is thus assumed for this example that system administrator “A” has rights to view such configuration data. System administrator “A” navigates to the UI showing the particular configuration setting which he/she desires to change. System administrator “A” then makes a request to change a configuration type 604, such as to change the password length from current length 1 to new length 2. This request may be made by entering text in fields on the webpage and clicking “save,” or by entering a rich semantic expression requesting such a change, etc. Upon receiving request 604, the criteria of the request are determined in step 606, in which the identity of the requester, the request type, the phase type, etc. are determined. The exemplary process 600 does not specify a particular phase for this example. Rather, process 600 is intended to show the consulting of mappings and triggering of workflows, in general, for any type of phase and request. Process 600 then proceeds to consult mapping 608, in which a pre-defined mapping matching the criteria determined in determination step 606 is consulted. From mapping 608, a list of workflows is returned 610 for the particular phase requested, e.g., authentication, authorization, and/or action. These workflows are then run in parallel 612, 620, 614 and 616. Any number of workflows may be run, as shown, for example, by the Workflow listing of “Workflow 1” 612, “Workflow 2” 620, ellipses 614, and “Workflow n” 616. Further, activities within workflows may be run, as depicted by activities 617, 618 and 622 in accordance with an embodiment of the present invention. Depending on the particular phase of which the workflows are associated, activities 617-622 may include Authentication, Notification, Logging, etc. An authentication activity may request additional data which validates the identity of the principal. Examples may include processes which request secrets from the user, such as, for example, “What is your mother's maiden name?” or physical validation of identity, such as, for example, Smartcard or Biometric devices. A notification activity, for example, may notify a third party (other than the principal and the supporting computer system) that a request has been made. A logging activity records the request to the system, e.g., providing for logging which supports later auditing or is instituted for purposes of detecting attacks on the system.

Following the execution of the workflows and/or activities, process 600 proceeds to query operation 624 in which it is determined whether all workflows and/or activities were successful. If they were not all successful, flow branches NO to abort operation 626 and an error message 634 is sent in accordance with an embodiment of the present invention. If all workflows and activities were successful, the particular processing request for the particular phase associated therewith is processed and process 600 terminates at End operation 628.

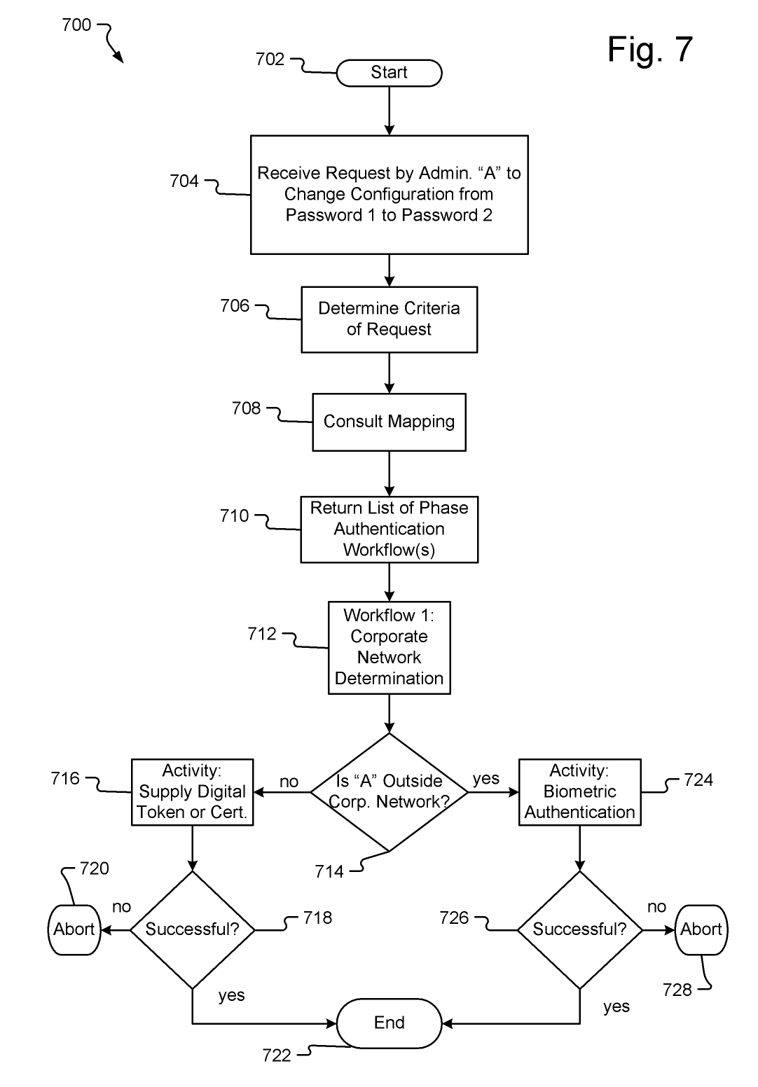

Having described the process of consulting mappings and triggering associated workflows and activities in general in process 600, FIG. 7 shows process 700 for consulting a mapping for a particular request and authentication phase and the triggering of a specific example of a workflow and associated activities in accordance with an embodiment of the present invention. Start operation 702 is initiated as described above for process 600, in which system administrator “A” having rights to view configuration settings navigates to the UI showing password reset settings. System administrator “A” enters a request to change the password reset configuration from password length 1 (8 characters) to password length 2 (10 characters). This request is received 704 by a processing module or other module in the system. Upon receiving this request, the criteria of the request are determined 706 and passed to the mapping module to consult a mapping 708 matching the criteria of the request. The mapping module calculates the workflows of the mapping and a list of workflows to run for the particular phase, requester, target, etc. is returned 710. For example purposes, operation 710 shows the return list of workflows for the authentication phase. Further, for example purposes, only one workflow 712 is shown in process 700; however, any number of workflows may be run depending on the particular mapping. Workflow 1 is triggered to determine whether the system administrator attempting to process configuration data is from outside a corporate network or from within the corporate network 712. Workflow 1 thus triggers the query 714 to determine if “A” is outside the corporate network. If “A” is outside the corporate network, flow branches YES to activity 724 to require “A” to pass biometric authentication before the request may be processed. If “A” passes this authentication at query operation 726, flow branches YES to end operation 722, in which process 700 terminates by executing the requested configurability change assuming that no other workflows, activities, or phases for the request are required (for the purposes of this example only). If “A” does not pass biometric authentication, flow branches NO to abort operation 728 and the requested action is not allowed to execute. Returning to query operation 714, if “A” is not outside the corporate network, flow branches NO to activity 716 in which “A” may be required to supply a digital token or certificate to authenticate himself/herself. Query operation 718 determines whether the supply of this token or certificate is successful. If YES, flow branches YES to end operation 722. If it is not successful, the request by “A” is not executed and flow branches NO to abort operation 720. Again, the examples provided herein of specific workflow 1 and activity types are offered by way of example only and are not intended in any way to limit the scope of this invention. While process 700 shows steps 702 through 728, a person of ordinary skill in the art would reasonably understand that these steps need not necessarily occur in the order shown. In addition, not all steps are required, and additional steps may be included without departing from the spirit and scope of the present invention.

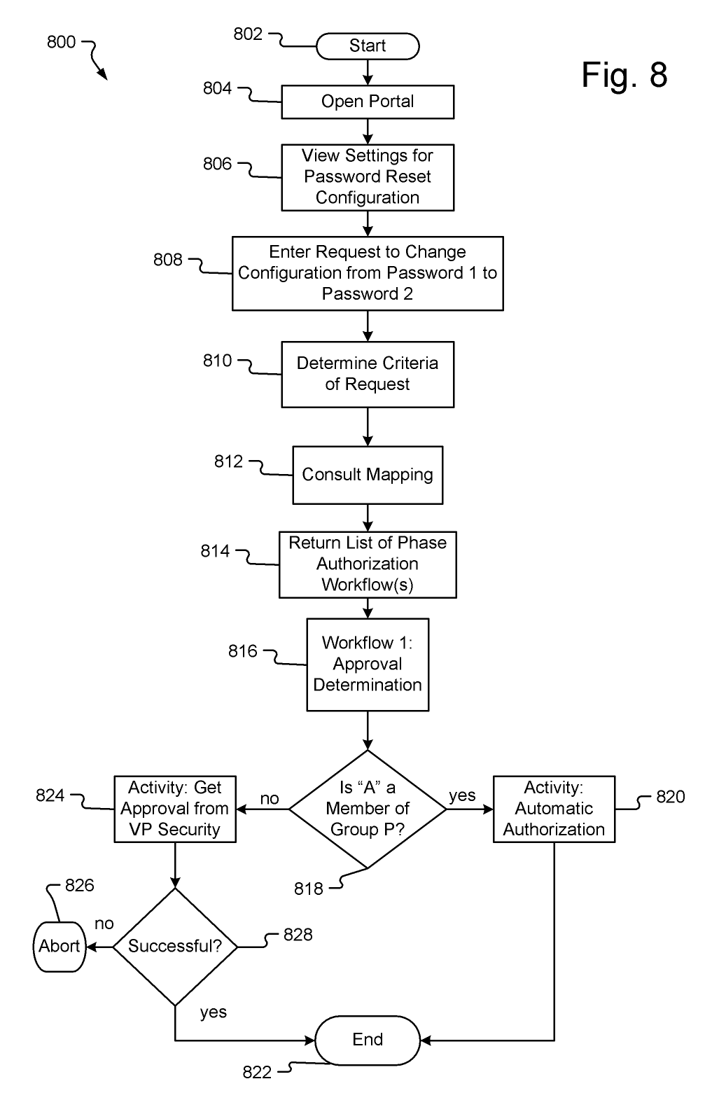

Turning to FIG. 8, process 800 for consulting a mapping and triggering workflows and associated activities for the authorization phase of a configuration processing request is shown in accordance with an embodiment of the present invention. In this example, Start 802 is initiated when system administrator “A” opens a general UI on his/her desktop. “A” then opens the portal 804 for configuration changes and views settings for password reset configuration 806 by navigating to these settings by selecting or clicking on a Tab or words or checkbox indicating such. On the password reset settings page, “A” enters a request 808 to change the password configuration from password length 1 to password length 2. The criteria of this request, including the authorization phase, are calculated 810 and a mapping associated with such criteria is consulted 812. For example, this mapping returns a list of authorization workflow(s) 814. For example purposes, only one workflow, i.e., Workflow 1, is shown in process 800; however, any number of workflows may be associated with a particular mapping. Workflow 1 Approval Determination 816 is triggered upon the entering of the configurability change request and consulting of mapping. This workflow is run to determine whether approval for the request change is required from a higher authority. Certain groups of employees may not need any approval from a higher authority, shown as Group “P” in process 800. Query operation 818 thus determines whether “A” is a member of Group “P”. If “A” belongs to Group “P,” flow branches YES and automatic authorization is granted in activity 820 and process 800 terminates at end operation 822, assuming there are no other workflows, activities, phases, etc. for carrying out the processing request. If “A” is not a member of Group “P,” flow branches NO to activity 824 to obtain approval for the request change from the Vice President of Security, as discussed above. If the VP of Security gives approval for the request change, the approval request is deemed to be successful at query operation 828 and flow branches YES to end operation 822. If the VP of Security does not give approval for the request change, flow branches NO to abort operation 826 and the request to change the password reset setting is not executed. While process 800 shows steps 802 through 828, a person of ordinary skill in the art would reasonably understand that these steps need not necessarily occur in the order shown. In addition, not all steps are required, and additional steps may be included without departing from the spirit and scope of the present invention.

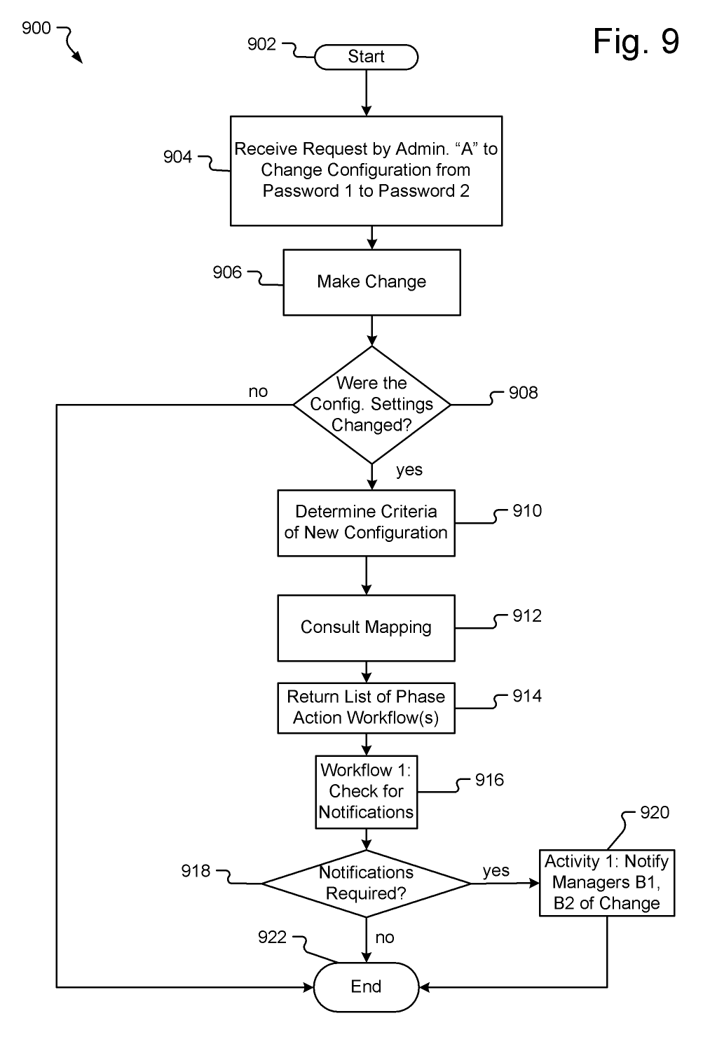

While FIGS. 7 and 8 have shown processes 700 and 800 for consulting a mapping and triggering workflows and associated activities for the authentication and authorization phases of a configuration processing request, FIG. 9 shows consulting of a mapping and triggering of workflows and activities for the action phase of a configuration processing request in accordance with an embodiment of the present invention. Start operation 902 is initiated and a request 904 is received to change the configuration of the password setup. Assuming the proper authorization and/or authentication is received for this request, the action is taken and the password configuration setup change is made 906. After making the change, process 900 proceeds to query 908 to determine if a configuration change was made. If no configuration change was made, process 900 proceeds to end operation 922 and the process terminates according to an embodiment of the present invention. In other embodiments, a notification or other indicator is sent to the requestor indicating that the change was not made. If a configuration change is detected, process 900 proceeds YES to determine the criteria of the resulting new configuration in operation 910. Upon evaluating these criteria, a mapping is consulted 912 through the use of a mapping module. Based on the mapping consulted, a list of workflow(s) for the particular criteria is returned 914. A workflow(s) is then triggered 916. For example purposes, only one workflow is shown in FIG. 9; however, a person of ordinary skill in the art would reasonably understand that there are numerous workflows, activities, and types of workflows and activities which could be triggered. Exemplary Workflow 1 shows that a check for notifications is triggered 916, in which it is then determined in query 918 whether it is necessary to notify anyone or any entity of the change made to the configuration. If notification is required, process 900 proceeds YES to Activity 1 to notify managers B1 and B2 of the change in operation 920. Such notification may occur through an email message, etc., although any number of ways of notifying may be reasonably understood by those of ordinary skill in the art. After notifying these managers, process 900 proceeds to end operation 922. If notification is not required, process 900 proceeds to end operation 922 in which the process terminates assuming there are no other workflows triggered and no other activities, phases, etc. While process 900 shows steps 902 through 922, a person of ordinary skill in the art would reasonably understand that these steps need not necessarily occur in the order shown. In addition, not all steps are required, and additional steps may be included without departing from the spirit and scope of the present invention.

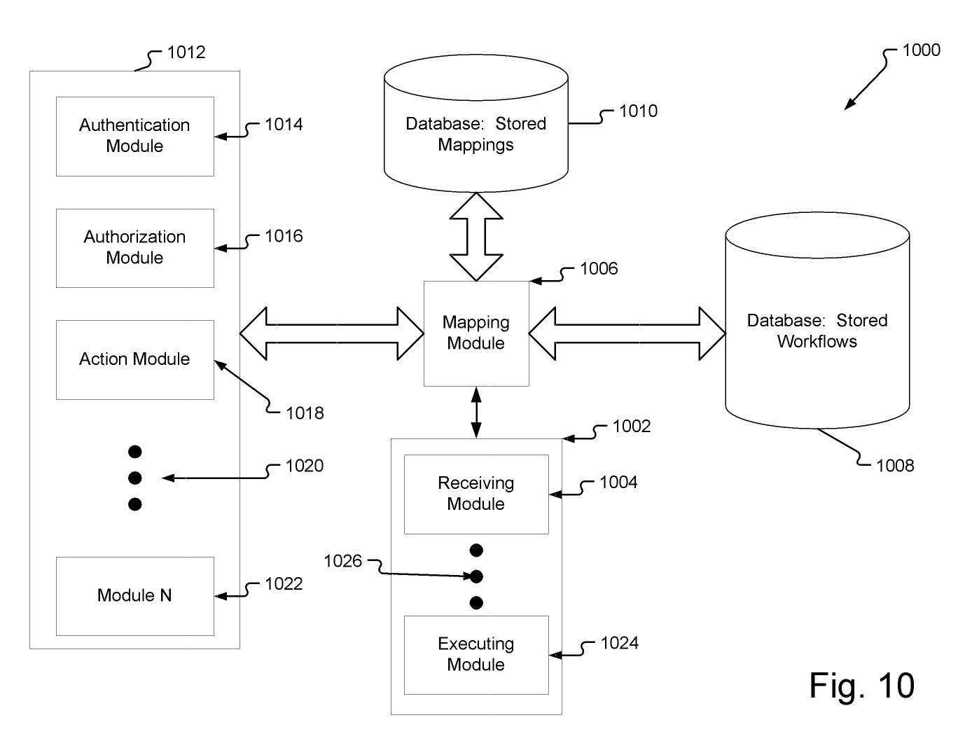

Having described the processes for creating and consulting a mapping and triggering workflows and activities associated therewith, FIG. 10 illustrates system 1000 comprising functional component modules for processing a software configuration processing request in accordance with an embodiment of the present invention. In an embodiment, the system 1000 comprises processing modules 1002 and 1012. The system 1000 further includes database 1008 for storing workflows and database 1010 for storing pre-defined mappings. A mapping module 1006 calculates the criteria of a particular request received by receiving module 1004 and creates maps by retrieving workflows from database 1008 and/or retrieves pre-defined mappings from database 1010. The mapping module then determines the workflows associated with particular phases of the processing request. Authentication module 1014, authorization module 1016, and action module 1018 execute associated workflows and/or activities based on the mapping provided by the mapping module 1006. Processing module 1012 may consist of any number of modules, as shown by ellipses 1020 and Module N 1022. The workflows associated with the various phases of processing the request may be executed by the particular phase modules 1014, 1016, and 1018 themselves, or may be executed by other processing modules, such as by processing module 1012, 1022, 1002, or executing module 1024. Any number of processing modules and databases may be used without departing from the scope of this invention. Multiple mapping modules could also be used. Further, means for storage other than databases could be used and reasonably understood by those of ordinary skill in the art.

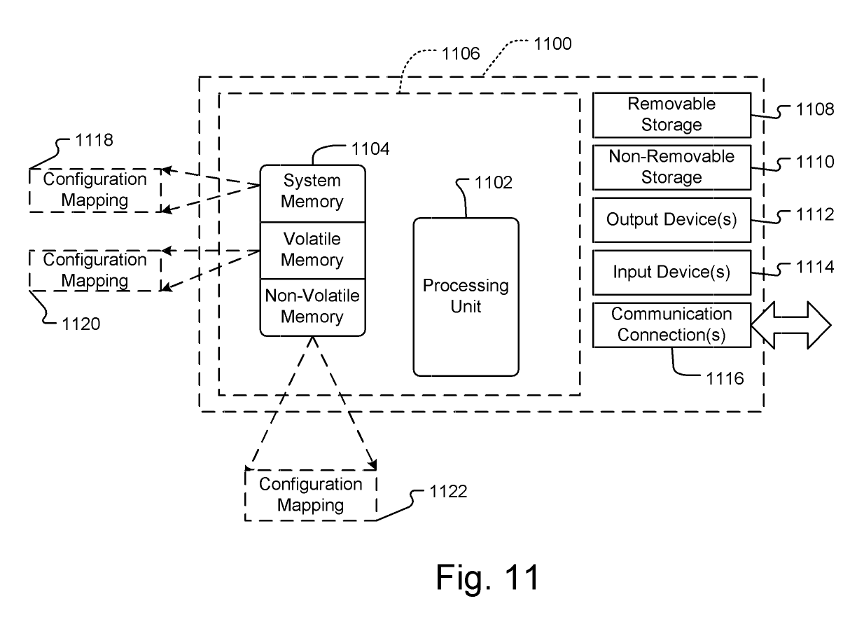

Finally, FIG. 11 illustrates an exemplary computing system 1100 upon which the present invention may be implemented. A computer system 1100, which has at least one processor 1102 for processing the requests shown in FIG. 1, is depicted. The system 1100 has a memory 1104, in which a mapping 1118 (or 1120 or 1122) is located. In its most basic configuration, computing system 1100 is illustrated in FIG. 11 by dashed line 1106. Additionally, system 1100 may also include additional storage (removable and/or non-removable) including, but not limited to, magnetic or optical disks or tape. Such additional storage is illustrated in FIG. 11 by removable storage 1108 and non-removable storage 1110. Computer storage media includes volatile and nonvolatile, removable and non-removable media implemented in any method or technology for storage of information such as computer readable instructions, data structures, program modules or other data. Memory 1104, removable storage 1108 and non-removable storage 1110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired mapping or processing information, for example, and which can be accessed by system 1100. Any such computer storage media may be part of system 1100. Depending on the configuration and type of computing device, memory 1104 may be volatile, non-volatile or some combination of the two. With respect to memory 1104, the mapping of the present invention could be in system memory 1118, volatile memory 1120, or non-volatile memory 1122 in accordance with embodiments of the present invention. The illustration in FIG. 11 is intended in no way to limit the scope of the invention. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

System 1100 may also contain communications connection(s) 1116 that allow the device to communicate with other devices. Additionally, to input content into the fields of the UI 200 in accordance with an embodiment of the invention, system 1100 may have input device(s) 1114 such as a keyboard, mouse, pen, voice input device, touch input device, etc. Output device(s) 1112 such as a display, speakers, printer, etc. may also be included, in which such devices may be used to display the UI for creating a mapping as shown in FIG. 2 in accordance with embodiments of the present invention. All of these devices are well known in the art and need not be discussed at length here.

Having described embodiments of the present disclosure with reference to the figures above, it should be appreciated that numerous modifications may be made to the present invention that will readily suggest themselves to those skilled in the art and which are encompassed within the scope and spirit of the invention disclosed and as defined in the appended claims. Indeed, while embodiments have been described for purposes of this disclosure, various changes and modifications may be made which are well within the scope of the present invention.

Similarly, although this disclosure has used language specific to structural features, methodological acts, and computer-readable media containing such acts, it is to be understood that the subject matter defined in the appended claims is not necessarily limited to the specific structure, acts, features, or media described herein. Rather, the specific structures, features, acts, and/or media described above are disclosed as example forms of implementing the claims. Aspects of embodiments allow for multiple request types, request combinations, request sub-combinations, multiple requesters, multiple targets, and multiple workflows. Or, in other embodiments, a single request could be made by a single requester for a single target with the association of a single workflow. One skilled in the art will recognize other embodiments or improvements that are within the scope and spirit of the present invention. Therefore, the specific structure, acts, or media are disclosed as exemplary embodiments of implementing the claimed invention. The invention is defined by the appended claims.

What is claimed is:

1. A method of processing a software configuration processing request, comprising:
receiving a request to change a configuration setting;
consulting a mapping to determine one or more repeatable processes associated with one or more phases of processing the configuration change request; and
executing the repeatable processes.

2. The method as defined in claim 1, wherein the phases of processing the configuration change request include one or more of: authentication, authorization, and action.

3. The method as defined in claim 2, wherein the phases of processing the configuration change request include an entity data change phase.

4. The method as defined in claim 1, wherein a repeatable process is triggered to obtain approval for the requested configuration change from an entity different from the one making the request.

5. The method as defined in claim 1, the method further comprising:
calculating criteria of the request; and
creating the mapping of one or more repeatable processes based on the criteria.

6. The method as defined in claim 5, wherein the mapping is created using a user interface.

7. The method as defined in claim 5, wherein the mapping is created using a rich semantic expression.

8. A system for processing a configuration processing request, comprising:
a module for receiving a request to change a configuration setting;
a mapping module for determining one or more repeatable processes associated with one or more phases of processing the change to configuration setting;
a storage module for storing one or more mappings;
a storage module for storing available repeatable processes;
a processing module for calculating the criteria of the request;
a processing module for consulting a mapping provided by the mapping module; and
an executing module for executing the repeatable processes defined in the mapping.

9. A system as defined in claim 8 wherein the processing module resides in an operating system.

10. A system as defined in claim 8, further comprising:
an authorization module for consulting a mapping to determine a workflow associated with an authorization phase; and
an authorization executing module for executing the authorization workflow.

11. A system as defined in claim 8, further comprising:
an authentication module for consulting a mapping to determine a workflow associated with an authentication phase; and
an authentication executing module for executing the authentication workflow.

12. A system as defined in claim 8, further comprising:
an action module for consulting a mapping to determine a workflow associated with an action phase; and
an action executing module for executing the action workflow.

13. A system as defined in claim 8, further comprising a mapping module to create a mapping of repeatable processes for certain criteria of a request and of the processing phase.

14. A system as defined in claim 8, wherein the processing module further executes activities associated with the repeatable processes.

15. A computer storage medium containing computer executable instructions that, when executed, implement the following steps:
receiving a request to change a configuration setting;
determining one or more repeatable processes associated with one or more phases of processing the configuration change request; and
executing the repeatable processes.

16. A computer storage medium as defined in claim 15, further comprising:
evaluating the criteria of the request; and
determining one or more repeatable processes associated with one or more attributes of the request.

17. A computer storage medium as defined in claim 15, wherein the phases of processing the configuration change request include one or more of: authentication, authorization, action, and entity data change.

18. A computer storage medium as defined in claim 15, wherein a repeatable process is triggered to obtain approval for the requested configuration change from an entity different from the one making the request.

19. A computer storage medium as defined in claim 15, further comprising:
calculating attributes of the request; and
creating the mapping of one or more repeatable processes based on the attributes.

20. A computer storage medium as defined in claim 15, wherein the mapping is created using one or more of: a user interface and a rich semantic expression.
